(19) United States
(12) Patent Application Publication
(10) Pub. No.: US 2009/0035998 A1
(43) Pub. Date: Feb. 5, 2009

(54) Pluggable Conductor Terminal

(75) Inventor: Andreas Schrader, Delbruck (DE)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: PHOENIX CONTACT GmbH & Co. KG, Blomberg (DE)

(21) Appl. No.: 12/180,908

(22) Filed: Jul. 28, 2008

(30) Foreign Application Priority Data
Jul. 31, 2007 (DE) 10 2007 036 295.3

(51) Int. Cl. H01R 9/16

(52) U.S. Cl. 439/709

(57) ABSTRACT

A pluggable conductor terminal includes a plug connector (6) with a pin guide (8) emptying into a contact space (5) and a conductor guide channel (24) with a conductor connection aperture (25) that is transformed into a central clamping space (19) in the clamp housing. The conductor guide channel (24) is inclined toward the pin guide (8). A contact piece (3) with a contact part (4) for the contact pin (7) is mounted in the contact space (5) with a clamp spring (15) for the conductor (33) in the clamping space (19). For the sake of simpler manufacture, the contact piece (3) and the clamp spring (15) are of one piece, and consist of an elongated, flat band (2) bent exclusively crosswise to its longitudinal dimension.

### TECHNICAL FIELD

The invention relates to a pluggable conductor terminal with an insulating housing and more particularly, to a conductor terminal for connecting a conductor with a pin on a printed circuit board, and wherein the terminal includes a one piece contact spring particularly bent and arranged within the insulating housing.

### BACKGROUND INFORMATION

In conventional models, such pluggable conductor terminals include a contact piece for which the contact part of the contact pin to be contacted and the clamp spring with a clamp point for the conductor to be connected consist of two or more parts that are joined together by means of welding or soldering. In the course of the miniaturization of such clamps whose disk-shaped insulating housings suited for row configuration include a width of magnitude of 3 mm, the contact parts and clamp springs possess correspondingly small dimensions, but must meet high requirements for positive function. Therefore, the weld or solder connection of the current- or voltage-conducting contact piece is performed with great precision, which is realizable only at high expense.

### SUMMARY

It is the task of the invention to provide a conductor terminal of the type mentioned at the outset whose contact part is simpler to produce.

It is essential to the invention that the contact piece and the clamp spring consist of a single part, namely a flat band bent exclusively crosswise to its longitudinal dimension. The peculiarity of the torsion spring is that it comes into contact with the connected conductor only by means of its clamp leg that is tensioned by the clamp leg against the clamp abutment formed by the insulating housing. The more or less point- or line-shaped contact point between the clamp leg and the clamped conductor is then adequate in any case if only low amounts of current flow through the metallic flat band.

### BRIEF DESCRIPTION OF THE DRAWINGS

These and other features and advantages of the present invention will be better understood by reading the following detailed description, taken together with the drawings wherein:

FIG. 1 is a perspective view of a spring-force print terminal seen from the open side of the insulating housing;

FIG. 2 is a perspective view of the print terminal of FIG. 1 during clamping or releasing a conductor; and

FIG. 3 is a perspective view of the bent flat band forming the contact piece and the clamp spring along with a contact pin.

### DETAILED DESCRIPTION OF THE PREFERRED EMBODIMENTS

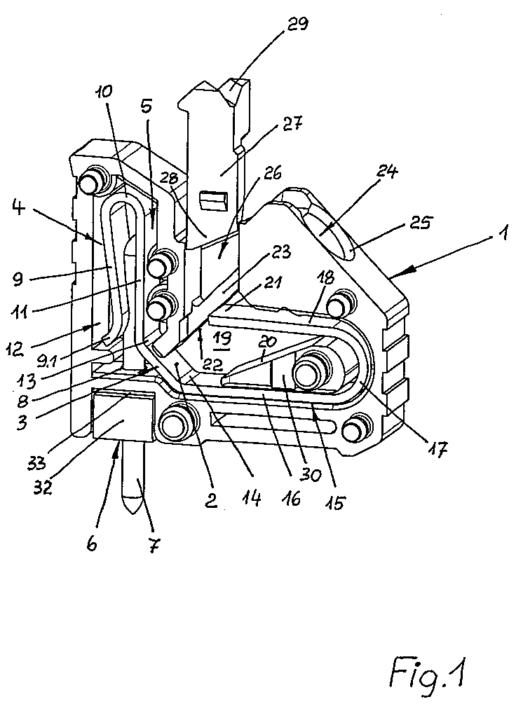

In particular, FIG. 1 shows an insulating housing 1 that is implemented as a narrow, disk-shaped housing suited for row configuration. In practical implementation, the housing 1 possesses a width of from 2.5˜3.5 mm. A current-conducting contact piece 3 is mounted within the housing 1 and includes two spatially-separated contact points, as will be explained in the following. The contact piece 3 consists of a flat, metallic band 2 bent exclusively crosswise to its longitudinal dimension. A flat band 2 is involved that possesses a constant width along its entire length.

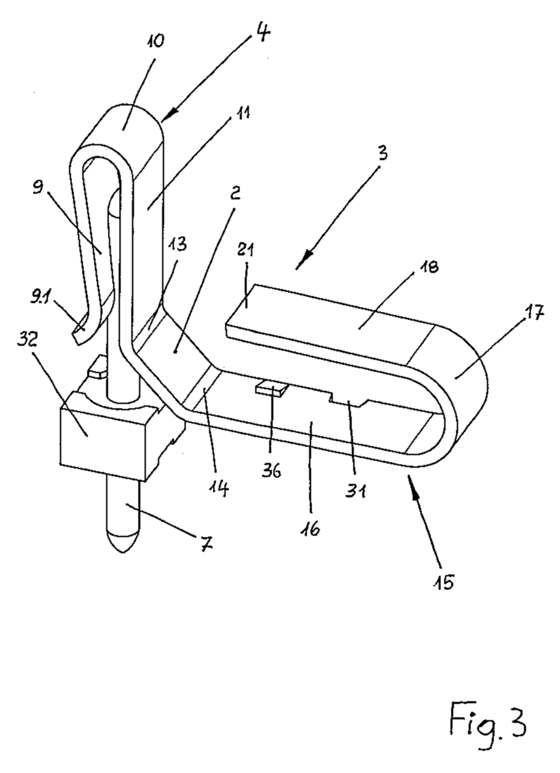

First, a spring tulip 4 is shaped from a flat, metallic band 2 that is positioned within a clamp chamber 5 of the insulating housing 1. The spring tulip 4 is the contact element for a plug connector 6 mounted on the floor of the insulating housing 1, by means of which the print terminal may be stacked onto a contact pin 7. Such a contact pin 7, as seen in FIG. 3, is firmly mounted on a circuit board (not shown) and is provided with a plastic block 32 by means of which it is supported on the circuit board. In plugged condition, the plastic block 32 is located within a receiver space 33 that is located in the vicinity of floor-mounted plug connector 6 of the insulating housing 1, and that is open toward its lower side. A pin guide 8 is adjacent to the receiver space that consists of a cylindrical penetrating aperture that connects together the receiver space 33 and the contact space 5 and serves for the passage of the contact pin 7.

The contact space 5 is an elongated space extending along the plug direction of the contact pin 7. This corresponds to the elongated shape of the spring tulip 4 that first consists of a spring leg 9 formed from one of the two ends of the flat band 2. The spring leg 9 passes over a flexible joint with an arc of more than 180° and is transformed into a support leg 11 that rests against an inner wall of the insulating housing 1. Therefore, when the contact pin 7 is inserted, only the spring leg 9 of the spring tulip 4 can expand, for which free space 12 is provided within the contact space 5 into which the spring leg 9 of the spring tulip 4 may expand. Insertion of the contact pin 7 into the spring tulip 4 is simplified by means of an end 9.1 of the spring leg 9 bent away from the supporting leg 11. The flexible joint 10 of the spring tulip 4 offset from the pin guide 8 toward which the spring tulip 4 opens upon insertion of the contact pin 7. The supporting leg 11 of the spring tulip 4 extends along a straight direction parallel to the contact pin 7, and the inner side of the supporting leg 11 of the spring tulip 4 lies tangential to the pin guide 8.

As FIGS. 1 and 3 further show, the metallic flat band 2 includes bends 13 and 14 each at an angle of approximately 135°, over which the supporting leg 11 is transformed into a bearing leg 16, which is a part of a torsion spring 15 formed from the flat band 2. Thus, the bearing leg 16 of the torsion spring 15 is perpendicular to the supporting leg 11 of the spring tulip 4, which is however, not absolutely required. A clamp leg 18 is connected to the flexor 17, which in turn is connected to the bearing leg 16 of the torsion spring 15. In the non-clamping initial position, the flexor 17 possesses a 180° arc, and is correspondingly parallel to the clamp leg 18 bent back into a bearing leg 16.

The section of the flat band 2 forming the torsion spring 15 is mounted within a clamping space 9 of the insulating housing 1, whereby the side of the bearing leg 16 facing away from the clamp leg 18 is supported by the entire surface of a wall of the clamping space 9 facing toward the bottom side of the insulating housing 1. A wedge-shaped strike surface 20 is located within the clamping space 19 with its upper side angled toward the non-jointed clamp leg 18. The clamp leg 18 strikes against this upper side upon depression so that the torsion spring 15 is not over-extended.

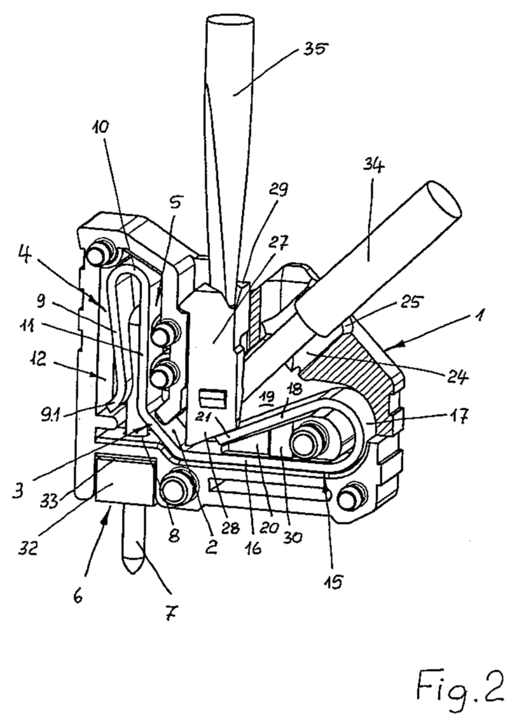

The second end of the flat band 2 forms a clamp end 21 at the clamp leg 18 that interacts with a clamp abutment 22. The clamp abutment 22 is formed by a clamping rib 23 of the insulating housing 1 projecting into the clamping space 19. The clamp abutment 22 of this clamping rib 23 extends at an angle of 45° to the plug direction of the contact pin 7. A conductor-guide channel 24 leads to the clamp abutment 22 at the same angle within the insulating housing 1, as FIG. 2 particularly shows. A conductor-connection aperture 25 is provided on the upper side of the insulating housing 1 that transforms into the conductor-connection channel. FIG. 2 shows its clamping direction oblique to the plug direction of the contact pin 7 using the conductor 24 shown there.

A guide channel 26 is formed into the insulating housing 1 between the conductor-guide channel 24 and the contact space 5 that receives the spring tulip 4. This guide channel 26 extends parallel to the plug direction of the contact pin 7. A pusher 27 is mounted within the guide channel 26 so that it may be displaced. The inner end 28 is designed to be narrow enough that, as FIG. 2 shows, it loads the clamp end 21 on the clamp leg 18 of the torsion spring 15 against the clamp rib 23 in the pressed-in position of the pusher 27. This is possible because the clamp rib 23 covers the clamp end 21 of the clamp leg 18 merely partially, preferably more than half.

As FIG. 2 shows, the pusher 27 includes an actuation end 29 suited to the insertion of a tool blade 35. Another peculiarity of the pusher is the fact that, in its initial (non-actuated) position shown in FIG. 1, it is injection-molded to the insulating housing 1. The connecting spars still existing are implemented as intended break points that are first separated upon first actuation of the pusher 27. The pusher 27 is simultaneously engaged into its position resting against the clamp end 21 of the clamp leg 18, which occurs at the blocked adjacent housing in the open implementation of the insulating housing 1.

Finally, FIG. 3 shows a recess 31 and also an engaging notch 36 that serve to secure the contact piece 3 formed of the flat band 2 in the insulating housing 1. For this, one may see a positioning rib 30 in FIG. 1 that projects into the clamping space 19 and engages with a friction fit into the recess 31 on the bearing leg 16 of the torsion spring 15.

Modifications and substitutions by one of ordinary skill in the art are considered to be within the scope of the present invention, which is not to be limited except by the allowed claims and their legal equivalents.

1. A Conductor terminal with an insulating housing (1) with a floor-mounted plug connector (6) to be plugged onto a contact pin (7) with a pin guide (8) in the housing that opens into a contact space (5), and with an upper-side conductor-connection aperture (25) to which a conductor guide channel (24) in the housing (1) that transforms into a central clamping space (19) is connected that inclines toward the pin guide (8), particularly at an angle of 45°, whereby a metallic contact piece (3) forming the current path with a contact part (4) for the contact pin (7) to be contacted within the contact space (5), and with a clamp spring (15) for the conductor to be connected (33), is mounted within the clamping space (19)
characterized in that
the contact piece (3) and the clamp spring (15) are of one piece, and that they consist of an elongated flat band (2) bent exclusively crosswise to its longitudinal dimension and whose section located within the clamping space is shaped into a torsion spring forming the clamp spring (15) with a bearing leg (16) connected to the spring tulip (4) supported within the housing (1) and with a clamp leg bent back toward the bearing leg via a flexor (17), whereby a housing-side clamp abutment (22) extending oblique to the clamp leg (18) is present which, in the clamped position of the clamp leg (18), tensions the conductor (33) in contact with it.

2. The terminal as in claim 1,
characterized in that
the spring tulip (4) of the contact piece (3) includes a supporting leg (11) firmly mounted within the contact space (5) and connected with the bearing leg (16) of the torsion spring (15), and a pivotable spring leg (9) bent back to it via a flexor (10) pivoted within a free space (12) in the contact space (5).

3. The terminal as in claim 2, characterized in that the supporting leg (11) of the spring tulip (4) at the contact piece (3) extends in a straight direction parallel to the plug direction of the contact pin (7) to be contacted.

4. The terminal as in claim 2,
characterized in that
the bearing leg (16) of the torsion spring (15) stands perpendicular to the supporting leg (11) of the spring tulip (4), whereby the clamp leg (18) of the torsion spring (15) in its non-clamping position is supported against the spring force parallel to the leg (16).

5. The terminal as in claim 4,
characterized in that
a strike surface limiting the path of the clamp leg (18) is positioned within the clamping space (19) between the bearing leg (16) and the clamp leg (18) of the torsion spring (15) that receives a housing-side positioning rib (30) with a friction fit.

6. The terminal as in claim 1, characterized in that the bearing leg (16) of the torsion spring (15) includes at least one recess (31) that receives a housing-side positioning rib (30) with an interference fit.

7. The terminal as in claim 1, characterized in that the clamp leg (18) of the torsion spring (15) interacts with a clamp rib (23) forming the clamp abutment (22) and projecting into the clamping space (19) that partially covers the clamp end (21) of the clamp leg (18) along the width dimension of the flat band (2), whereby a pusher is mounted within the housing (1) so that it may be displaced that possesses an inner end (28) that loads the clamp end (21) of the clamp leg (18) in the area not covered by the housing-side clamp rib (23).

8. The terminal as in claim 7, characterized in that the pusher (27) is guided into a guide channel adjacent to the contact space (5) in a direction parallel to the plug direction of the plug connector (6), and possesses an actuation end (29) exposed on the upper side of the housing (1).
